(19) United States
(12) Patent Application Publication
(10) Pub. No.: US 2025/0075993 A1
(43) Pub. Date: Mar. 6, 2025

(54) Firearm Tracking Assembly

(71) Applicant: Carl Cothren, Granbury, TX (US)

(72) Inventor: Carl Cothren, Granbury, TX (US)

(21) Appl. No.: 18/240,058

(22) Filed: Aug. 30, 2023

(51) Int. Cl. F41A 17/06; G01S 19/16

(52) U.S. Cl. CPC F41A 17/063; G01S 19/16

(57) ABSTRACT

A firearm tracking assembly for tracking a firearm when the firearm is stolen includes a firearm that has a grip which can be gripped by a user when the user is firing the firearm. A tracking unit is insertable into the grip of the firearm thereby concealing the tracking unit to inhibit an individual from removing the tracking unit from the firearm. The tracking unit is in communication with an extrinsic communication network to facilitate law enforcement to track the location of the firearm when the firearm is stolen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking devices and more particularly pertains to a new tracking device for tracking the location of a firearm in the event that the firearm is stolen. The device includes a tracking unit that can be installed in a grip of a firearm which is in wireless communication with an extrinsic communication network to facilitate a personal electronic device to receive a tracking signal from the tracking unit to facilitate law enforcement to track the firearm when the firearm is stolen.

### (2) Description of Related Art Including Information Disclosed Under 37 CFR 1.97 and 1.98

The prior art relates to tracking devices including a variety of tracking units that are attached to or integrated into a firearm and it at least one instance is in mechanical communication with a firing mechanism of the firearm to disable the firearm. In no instance does the prior art disclose a tracking unit that can be installed in a grip of a firearm which is in direct communication with an extrinsic communication network to facilitate a personal electronic device to receive a tracking signal from the tracking unit to facilitate law enforcement to track the firearm when the firearm is stolen.

### BRIEF SUMMARY OF THE INVENTION

An embodiment of the disclosure meets the needs presented above by generally comprising a firearm that has a grip which can be gripped by a user when the user is firing the firearm. A tracking unit is insertable into the grip of the firearm thereby concealing the tracking unit to inhibit an individual from removing the tracking unit from the firearm. The tracking unit is in communication with an extrinsic communication network to facilitate law enforcement to track the location of the firearm when the firearm is stolen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tracking unit of an embodiment of the disclosure.

FIG. 2 is a schematic view of an embodiment of the disclosure.

FIG. 3 is a perspective view of a firearm tracking assembly according to an embodiment of the disclosure.

FIG. 4 is an exploded perspective view of an embodiment of the disclosure showing a tracking unit being installed in a buttstock of a rifle.

FIG. 5 is a perspective in-use view of an embodiment of the disclosure.

### DETAILED DESCRIPTION OF THE INVENTION

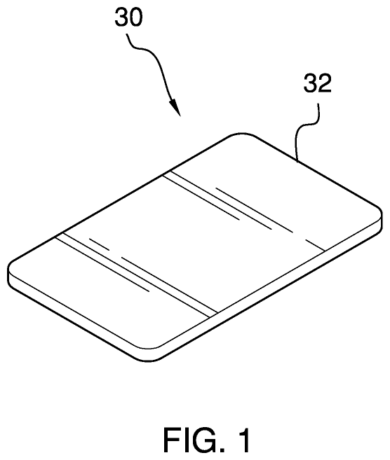

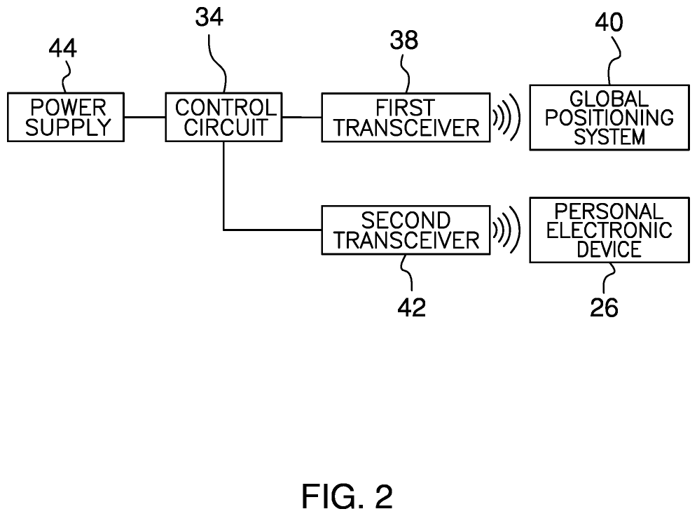

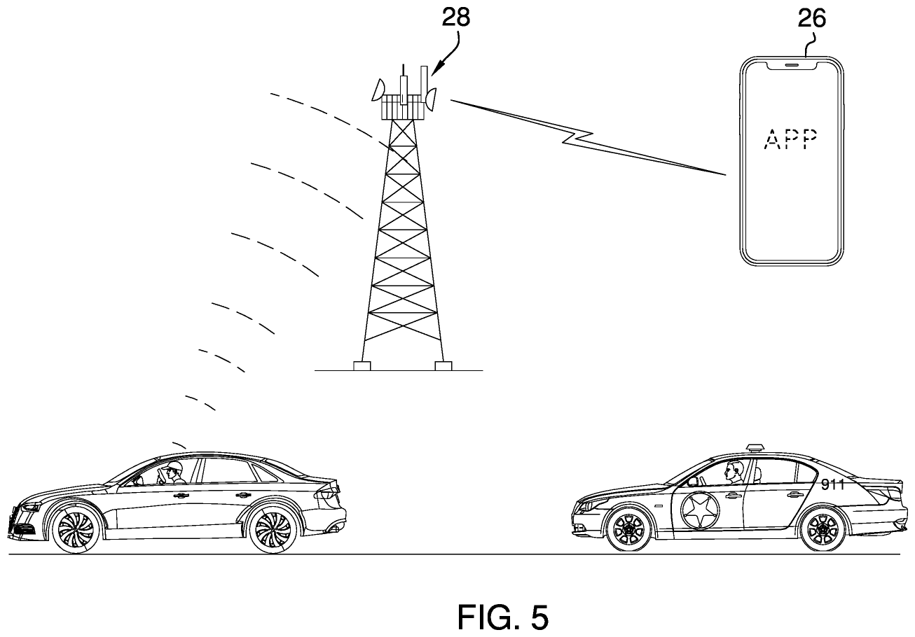

With reference now to the drawings, and in particular to FIGS. 1 through 5 thereof, a new tracking device embodying the principles and concepts of an embodiment of the disclosure and generally designated by the reference numeral 10 will be described.

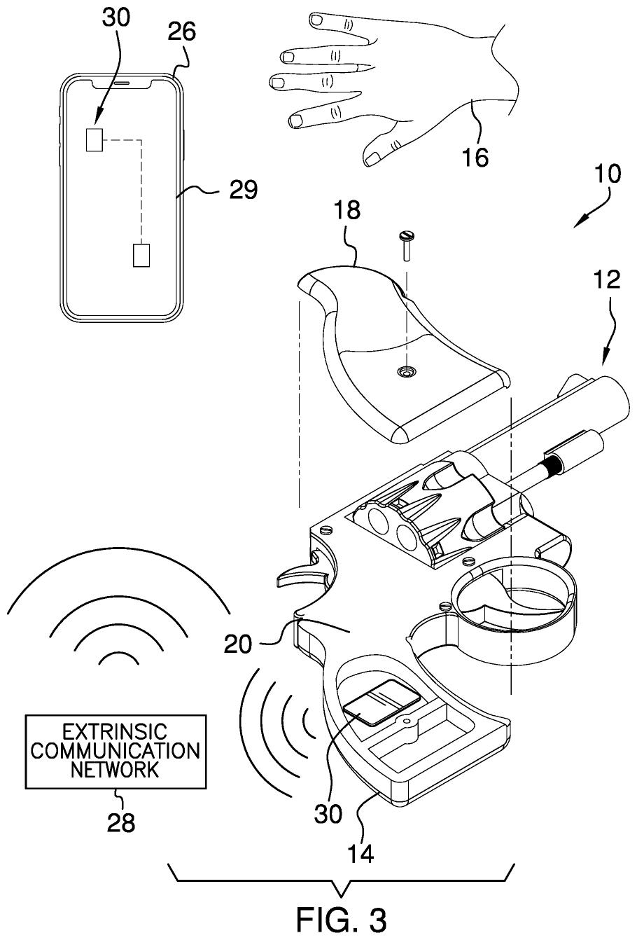

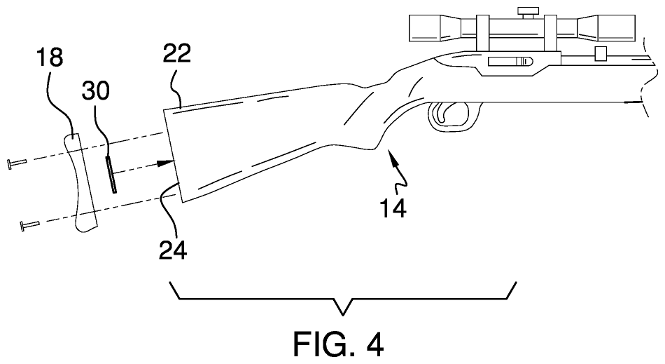

As best illustrated in FIGS. 1 through 5, the firearm tracking assembly 10 generally comprises a firearm 12 that has a grip 14 which can be gripped by a user 16 when the user 16 is firing the firearm 12. The grip 14 has a cover 18 that is removably attached to the grip 14 such that the cover 18 conceals an interior of the grip 14. As shown in FIG. 3, the firearm 12 may be a pistol and the cover 18 may be attachable to a lateral side 20 of the grip 14. As shown in FIG. 4, the firearm 12 may be a rifle and the grip 14 may include a buttstock 22 and the cover 18 may be attachable to an end 24 of the buttstock 22. Moreover, the firearm 12 may be a firearm of any conventional design, including but not being limited to, semi-automatic handguns, shotguns and semi-automatic assault rifles.

A personal electronic device 26 is included which is in wireless communication with an extrinsic communication network 28. The personal electronic device 26 stores digital data which comprises a tracking program. Additionally, the personal electronic device 26 has a display 29 which displays indicia 30 comprising images and words to facilitate the user 16 to view information related to the tracking program. The personal electronic device 26 may comprise a smart phone or other type of electronic device with wireless communication capabilities and an electronic display. Additionally, the extrinsic communication network 28 may comprise the internet, a cellular phone network or any other type of wireless communication network.

A tracking unit 30 is insertable into the grip 14 of the firearm 12 thereby concealing the tracking unit 30. In this way an individual is inhibited from removing the tracking unit 30 from the firearm 12. The tracking unit 30 is in communication with the extrinsic communication network 28 to facilitate law enforcement 31 to track the location of a thief when the thief has stolen the firearm 12. The tracking unit 30 comprises a housing 32 that is positionable within the grip 14 of the firearm 12 and a control circuit 34 that is integrated into the housing 32. The control circuit 34 includes an electronic memory 36 which stores a database comprising the serial number of the firearm 12.

The tracking unit 30 includes a first transceiver 38 that is integrated into the housing 32 and the first transceiver 38 is electrically coupled to the control circuit 34. The first transceiver 38 is in wireless communication with a global positioning system 40 to facilitate the control circuit 34 to identify the physical location of the firearm 12. The first transceiver 38 may comprise a radio frequency transceiver or the like commonly employed in global positioning systems. The tracking unit 30 includes a second transceiver 42 that is integrated into the housing 32 and the second transceiver 42 is electrically coupled to the control circuit 34. The second transceiver 42 is in wireless communication with the extrinsic communication network 28 thereby facilitating the second transceiver 42 to broadcast the physical location of the firearm 12 to the personal electronic device 26. In this way the personal electronic device 26 facilitates the user 16 to track the location of the firearm 12 when the firearm 12 is stolen. The second transceiver 42 may comprise a radio frequency transceiver or the like and the second transceiver 42 may employ a WPAN signal or other proprietary signal for communicating with a public communication network. The tracking unit 30 includes a power supply 44 that is integrated into the housing 32; the power supply 44 is electrically coupled to the control circuit 34 and the power supply 44 comprises at least one battery.

In use, the tracking unit 30 is installed in the grip 14 of the firearm 12 and the cover 18 is installed on the grip 14 to conceal the tracking unit 30. The tracking application in the personal electronic device 26 is employed to trigger the tracking unit 30 to begin broadcasting the location of the firearm 12 to the extrinsic communication unit. In this way the firearm 12 can be tracked by law enforcement in the event that the firearm 12 has been stolen to facilitate the firearm 12 to be retrieved. Additionally, the serial number of the firearm 12 stored in the electronic memory 36 facilitates the firearm 12 to be identified in the event that the serial number on the firearm 12 is filed off. Additionally, the tracking unit 30 facilitates the firearm 12 to be located in the event that an authorized user of the firearm 12 has not returned home from hunting or other type outdoor activity to assist with emergency responders with locating the firearm 12 and the authorized user. Furthermore, the tracking unit 30 facilitates law enforcement to be notified in the event that the firearm 12 has been taken into an area that prohibits the possession of firearms, such as a church or a school for example, thereby enhancing the ability of law enforcement to respond to a potential active shooter.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A firearm tracking assembly for tracking the location of a firearm in the event of a theft, said assembly comprising:
a firearm having a grip wherein said grip is configured to be gripped by a user when the user is firing said firearm; and
a tracking unit being insertable into said grip of said firearm thereby concealing said tracking unit wherein said tracking unit is configured to inhibit an individual from removing said tracking unit from said firearm, said tracking unit being in communication with an extrinsic communication network wherein said tracking unit is configured to facilitate law enforcement to track the location of said firearm when said firearm is stolen.

2. The assembly according to claim 1, wherein said tracking unit comprises:
a housing being positionable within said grip of said firearm;
a control circuit being integrated into said housing, said control circuit including an electronic memory storing a database comprising the serial number of said firearm; and
a first transceiver being integrated into said housing, said first transceiver being electrically coupled to said control circuit, said first transceiver being in wireless communication with a global positioning system wherein said first transceiver is configured to facilitate said control circuit to identify the physical location of said firearm.

3. The assembly according to claim 1, wherein said assembly includes a personal electronic device being in wireless communication with said extrinsic communication network, said personal electronic device storing digital data comprising a tracking program, said personal electronic device having a display which displays indicia comprising images and words wherein said display is configured to facilitate the user to view information related to said tracking program.

4. The assembly according to claim 2, wherein said tracking unit includes a second transceiver being integrated into said housing, said second transceiver being electrically coupled to said control circuit, said second transceiver being in wireless communication with said extrinsic communication network thereby facilitating said second transceiver to broadcast said physical location of said firearm to said personal electronic device wherein said personal electronic device is configured to facilitate the user to track the location of said firearm when said firearm is stolen.

5. A firearm tracking assembly for tracking the location of a firearm in the event of a theft, said assembly comprising:
a firearm having a grip wherein said grip is configured to be gripped by a user when the user is firing said firearm, said grip having a cover being removably attached to said grip such that said cover conceals an interior of said grip;
a personal electronic device being in wireless communication with an extrinsic communication network, said personal electronic device storing digital data comprising a tracking program, said personal electronic device having a display which displays indicia comprising images and words wherein said display is configured to facilitate the user to view information related to said tracking program; and
a tracking unit being insertable into said grip of said firearm thereby concealing said tracking unit wherein said tracking unit is configured to inhibit an individual from removing said tracking unit from said firearm, said tracking unit being in communication with said extrinsic communication network wherein said tracking unit is configured to facilitate law enforcement to track the location of said firearm when said firearm is stolen, said tracking unit comprising:
a housing being positionable within said grip of said firearm;
a control circuit being integrated into said housing, said control circuit including an electronic memory storing a database comprising the serial number of said firearm;
a first transceiver being integrated into said housing, said first transceiver being electrically coupled to said control circuit, said first transceiver being in wireless communication with a global positioning system wherein said first transceiver is configured to facilitate said control circuit to identify the physical location of said firearm;
a second transceiver being integrated into said housing, said second transceiver being electrically coupled to said control circuit, said second transceiver being in wireless communication with said extrinsic communication network thereby facilitating said second transceiver to broadcast said physical location of said firearm to said personal electronic device wherein said personal electronic device is configured to facilitate the user to track the location of said firearm when said firearm is stolen; and
a power supply being integrated into said housing, said power supply being electrically coupled to said control circuit, said power supply comprising at least one battery.
